(19) United States
(12) Patent Application Publication
(10) Pub. No.: US 2008/0050573 A1
(43) Pub. Date: Feb. 28, 2008

(54) Silicon Nanosheet , Nanosheet Solution and Process for Producing the Same, Nanosheet -Containing Composite, and Nanosheet Aggregate

(75) Inventors: Hideyuki Nakano, Aichi-ken (JP); Hiroshi Nakamura, Aichi-ken (JP); Takuya Mitsuoka, Aichi-ken (JP); Yusuke Akimoto, Aichi-ken (JP); Eiichi Sudo, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toyota Chuo Kenkyusho, Aichi-ken (JP)

(21) Appl. No.: 11/628,031

(22) PCT Filed: Jul. 14, 2005
(86) PCT No.: PCT/JP05/13050

§ 371 Date: Nov. 30, 2006

(30) Foreign Application Priority Data
Jul. 16, 2004 (JP) 2004-210290

(51) Int. Cl. B32B 9/00; C01B 15/14

(52) U.S. Cl. 428/220; 423/325; 428/336; 977/755

(57) ABSTRACT

A silicon nanosheet comprising a silicon atom layer formed by bonding two-dimensionally and periodically arranged silicon atoms to each other through an Si—Si bond. A nanosheet solution prepared by dispersing or suspending the silicon nanosheets in a solvent. A nanosheet-containing composite having the silicon nanosheets on the surface and/or in the interior of a substrate. A nanosheet aggregate formed by aggregating the silicon nanosheets. A process for producing a nanosheet solution comprising: an acid treatment step of bringing a layered silicon compound into contact with an aqueous acid solution to derive a siloxene compound; and an exfoliation step of adding the siloxene compound into a solvent containing a surfactant, shaking the mixture, and peeling off the siloxene compound.

### FIELD OF THE INVENTION

The present invention relates to: a silicon nanosheet comprising a single silicon atom layer formed by arranging silicon atoms two-dimensionally and periodically; a silicon nanosheet formed by aggregating plural such silicon atom layers; a nanosheet solution containing the silicon nanosheet and a process for producing the nanosheet solution; a nanosheet aggregate; and a nanosheet-containing composite.

### BACKGROUND OF THE INVENTION

Silicon has heretofore been widely used as an important electronic material for a semiconductor integrated circuit, a thin-film transistor, and the like. Silicon has excellent characteristics as a material for an electronic device and is used also as an electronic data processing device such as a DRAM, an LSI, or the like. Meanwhile, a hydrogenated/hydroxylated compound, such as siloxene (Si₆O₃H₆) or the like, which is a compound having a layered silicon skeleton, porous silicon, hydrogenated amorphous silicon, and others are known as luminous materials.

Recently it has been found that porous silicon formed by electrochemically etching a silicon substrate has the capability of visible light emitting (refer to L. T. Canham, “Silicon quantum wire array fabrication by electrochemical and chemical dissolution of wafers,” Applied Physics Letters, AMERICAN INST. OF PHYSICS, U.S.A., Sep. 3, 1990, p. 1046 to 1048). The light-emitting mechanism of porous silicon has not been clarified yet but it is estimated that the light emission is caused by a quantum effect, a surface structure, or a surface oxide film.

Meanwhile in recent years, research on a nanosheet comprising a semiconductor material such as TiO₂, MnO₂, Ca₂Nb₃O₁₀, or the like has actively been worked on. TiO₂ can be obtained from Cs_{0.7}Ti_{1.825}O₄ as lepidocrocite type layered titanate (refer to T. Sasaki and M. Watanabe, Journal of the American Chemical Society, U.S.A., 1998, Vol. 120, p. 4682 to 4689), MnO₂ can be obtained from K_{0.45}MnO₂ as layered manganese oxide of an α-NaFeO₂ type associated structure (refer to JP-A No. 335522/2003 and Y. Omomo, T. Sasaki, L. Z. Wang and M. Watanabe, Journal of the American Chemical Society, U.S.A., 2003, Vol. 12, p. 3568 to 3575), and Ca₂Nb₃O₁₀ can be obtained from KCa₂Nb₃O₁₀ of a layered perovskite structure (refer to Y. Ebina, T. Sasaki and M. Watanabe, Solid State Ionics, U.S.A., 2002, Vol. 151, p. 177 to 182). In any of the cases, a nanosheet is produced by: exchanging ions between layers for hydrogen ions; thereafter intercalating quaternary ammonium ions (particularly tetrabutyl ammonium) between the layers; expanding the gap between the layers by hydration swelling and violently shaking it; and thereby peeling off a layered compound.

With regard to silicon materials, nanocrystal silicon is cited as a nanoscale material. Nanocrystal silicon: shows quantum effect-which a conventional silicon material does not show; and hence attracts attention as a novel electronic material and the like. It is known that the nanocrystal silicon can generally be produced by, for example, a process of: simultaneously sputtering silicon and quartz glass; thereby forming an amorphous film wherein Si is excessively contained in SiO₂ on another silicon substrate; and applying heat treatment at 900° C. to 1,100° C. (refer to JP-A No. 040348/2001).

With such background, the development of porous silicon and nanocrystal silicon as electronic materials for the next generation has been worked on increasingly actively in recent years. The development of a useful silicon material having a novel structure has been desired with the aim of using it as a more novel electronic material or a more novel luminous material.

In the case of nanocrystal silicon, however, the nanocrystal silicon is an indirect transition semiconductor and it requires the change of momentum when an excited carrier falls into a ground state. As a result, the nanocrystal silicon has a low luminous efficiency and has not been suitable for a luminous material for a luminous element and the like.

Further, nanocrystal silicon has very fewer variations in the synthesis process thereof in spite of the fact that it is very highly appreciated as an electronic material and the like in practical use. As a process of synthesizing nanocrystal silicon, the process of forming an SiO₂ film containing an excessive amount of Si under a reduced pressure and annealing the film at a high temperature of the vicinity of 1,000° C. has mainly been used.

In contrast, in the case of a nanosheet comprising silicon, quantum effect and luminousness can be expected and hence the nanosheet is expected as a novel electronic material and a novel luminous material. However, all of the materials which have heretofore been successful in forming a nanosheet have been transition metal oxide and there has not been a case where a nanosheet comprising non-oxide silicon is produced.

### SUMMARY OF THE INVENTION

An object of the present invention is to provide: a novel silicon nanosheet wherein silicon atoms are arranged two-dimensionally and periodically; a nanosheet solution wherein the silicon nanosheets disperse and suspend and a process for producing the nanosheet solution; a nanosheet aggregate formed by aggregating silicon nanosheets; and a nanosheet-containing composite which contains silicon nanosheets.

Further, another object of the present invention is to provide a silicon nanosheet having a high luminous efficiency and being useful as an electronic material.

A silicon nanosheet according to the present invention which attains the above objects is a silicon nanosheet comprising a silicon atom layer formed by bonding two-dimensionally and periodically arranged silicon atoms to each other through an Si—Si bond.

Further, a nanosheet solution according to the present invention is a nanosheet solution prepared by dispersing or suspending the silicon nanosheets according to the present invention in a solvent.

Furthermore, a nanosheet-containing composite according to the present invention is a nanosheet-containing composite having the silicon nanosheets according to the present invention on the surface and/or in the interior of a substrate.

Yet further, a nanosheet aggregate according to the present invention is a nanosheet aggregate formed by aggregating the silicon nanosheets according to the present invention.

Still further, a process for producing a nanosheet solution according to the present invention comprises: an acid treatment step of bringing a layered silicon compound into contact with an aqueous acid solution to derive a siloxene compound; and an exfoliation step of adding the siloxene compound into a solvent containing a surfactant, shaking the mixture, and peeling off the siloxene compound.

In addition, another process for producing a nanosheet solution according to the present invention comprises: a hydrothermal treatment step of dispersing a layered silicon compound in a solvent comprising a mixture of an amine having 3 or more carbon atoms and water and applying hydrothermal treatment; and a separation step of separating unreacted materials.

When a layered silicon compound reacts with acid, the interlayer atoms of the layered silicon compound are replaced with acid molecules and a siloxene compound is formed. Successively, when a surfactant is added to a solution containing the siloxene compound and the mixture is shaken, the surfactant intrudes between layers and the siloxene compound swells infinitely. Otherwise, when a kind of amine is added to a layered silicon compound and the mixture is subjected to hydrothermal treatment, bulky amines are substituted for the interlayer atoms of the layered silicon compound and the layered silicon compound swells infinitely. As a result, a silicon nanosheet containing a single silicon atom layer or plural silicon atom layers is obtained.

A thus obtained silicon nanosheet is substantially composed of Si atoms, has two-dimensional anisotropy, and hence shows such unprecedentedly excellent characteristics as stated below. That is, a thus obtained silicon nanosheet:
(1) emits fluorescence of specific wavelengths with a specific excitation wavelength;
(2) has a remarkably large bandgap in comparison with bulk silicon;
(3) is excellent in traceability of a shape when a substrate surface is coated with the nanosheet;
(4) has an extremely high surface to volume ratio;
(5) exhibits high catalytic performance in the event of chemical reaction; and
(6) has a high thermal conductivity.

A silicon nanosheet according to the present invention can be used for: an electronic material constituting a semiconductor integrated circuit, a thin-film transistor, and others; a luminous element; an electronic element; a chemical catalyst; a catalyst carrier; a negative electrode active material for a lithium secondary battery; and others.

Further, a nanosheet solution according to the present invention can be used for: a liquid fluorescent agent; a raw material for the production of a nanosheet-containing composite and a nanosheet aggregate; and others.

Furthermore, a nanosheet-containing composite according to the present invention can be used for: various kinds of electronic elements; a heat radiating sheet; a raw material for a powder magnetic core; and others.

In addition, a nanosheet aggregate according to the present invention can be used for: various kinds of catalyst carriers; a negative electrode active material for a lithium secondary battery; an absorbent; and others.

### BRIEF DESCRIPTION OF THE DRAWINGS

FIG. 1 is a view showing the crystal structure of a silicon nanosheet according to a first embodiment of the present invention;

FIG. 2 is a view showing the crystal structure of CaSi₂ which is a kind of layered silicon compound;

FIG. 3 is a view showing the crystal structure of a siloxene compound derived from CaSi₂;

FIG. 4 is a view showing the crystal structure of a compound wherein acid molecules in the Si layered network structure of the siloxene compound shown in FIG. 3 are replaced with a surfactant;

FIG. 5 is an explanatory view showing a state wherein silicon atom layers peel off from the compound shown in FIG. 4;

FIG. 6 shows an X-ray diffraction pattern of a nanosheet solution obtained in Example 1;

FIG. 7 is a view showing the result of observing a silicon nanosheet obtained in Example 1 with an atomic force microscope (AFM);

FIG. 8 shows an electron diffraction pattern of a silicon nanosheet obtained in Example 1;

FIG. 9 shows a fluorescence spectrum of a nanosheet solution obtained in Example 1;

FIG. 10 is a perspective view showing the wholeness of a nanosheet-containing composite obtained in Example 3;

FIG. 11 is an enlarged partial view of a section of the nanosheet-containing composite shown in FIG. 10;

FIG. 12 shows a fluorescence spectrum of a nanosheet-containing composite obtained in Example 3;

FIG. 13 is a view showing the crystal structure of YbSi₂ which is a kind of layered silicon compound;

FIG. 14 is a view showing the crystal structure of a silicon nanosheet according to a second embodiment of the present invention;

FIG. 15 shows an electron diffraction pattern of a silicon nanosheet obtained in Example 7;

FIG. 16 shows a TEM photograph of an end of a silicon nanosheet obtained in Example 7;

FIG. 17 shows a result of EDX analysis of a silicon nanosheet obtained in Example 7;

In FIG. 18, FIG. 18A is a view showing the crystal structure of a diamond and FIG. 18B is a view showing the crystal structure of a silicon nanosheet obtained in Example 7; and

FIG. 19 shows a result of UV-vis measurement of a silicon nanosheet obtained in Example 7.

### DETAILED DESCRIPTION OF THE PREFERRED EMBODIMENTS

An embodiment according to the present invention is hereunder explained in detail.

A silicon nanosheet according to the present invention contains a silicon atom layer.

In the present invention, the term “a silicon atom layer” means a single atom layer formed by bonding two-dimensionally and periodically arranged silicon atoms to each other through an Si—Si bond.

Further, the term “two-dimensionally arranged silicon atoms” means that plural silicon atoms are arranged periodically in the directions of a and b axes (in the directions parallel with the layer plane) and substantially only one Si atom exists in the direction of c axis (in the direction perpendicular to the layer plane).

A silicon nanosheet according to the present invention comprises a single silicon atom layer or a layered product formed by laminating plural silicon atom layers.

In the case of a silicon nanosheet comprising a single silicon atom layer (hereunder referred to as “a single layered nanosheet”), the thickness thereof is about 0.5 to 1 nm. The thickness of a silicon atom layer somewhat varies in accordance with the structure thereof. For example, when silicon atoms are regularly arranged so as to form the same structure as a (111) plane in a diamond structure, the thickness of the single layered nanosheet is 0.6 to 0.8 nm.

A single layered nanosheet has a large size-anisotropy (the ratio of a width to a thickness). As a result, when a substrate or the like is coated with a silicon nanosheet for example, the shape of the surface of the substrate can be traced in a well reproducible manner. Further, since the area of the sheet is remarkably large in comparison with the thickness thereof, the surface of the substrate can efficiently be coated without largely changing the shape of the substrate surface.

In contrast, in the case of a silicon nanosheet comprising a layered product formed by laminating plural silicon atom layers (hereunder referred to as “a multilayered nanosheet”), the thickness thereof increases in proportion to the number of the silicon atom layers. By using a production process to be described later and optimizing the production conditions, it is possible to synthesize a silicon nanosheet about 10 to 20 nm in thickness.

Further, when a silicon nanosheet according to the present invention is used for a luminous element, an indicating element, or the like, a preferable thickness thereof is 10 nm or less. When the thickness of a silicon nanosheet exceeds 10 nm, the quantum size effect does not show up and hence it may undesirably be impossible to emit fluorescence with a specific excitation wavelength.

The width of a silicon nanosheet depends on the after-mentioned production conditions (for example, agitation strength at shaking in an exfoliation step, or the like). By using the after-mentioned process, a nanosheet 10 nm to 10 μm in width can be obtained. In general, when the width of a silicon nanosheet is less than 10 nm, the nanosheet tends to reaggregate in a liquid. On the other hand, when the width of a silicon nanosheet exceeds 1 μm, the nanosheet tends to precipitate. In order to suppress the reaggregation and precipitation of a nanosheet, a preferable width of the nanosheet is 50 to 500 nm.

A silicon nanosheet has various kinds of structures and compositions in accordance with the production conditions. Concretely there are following examples.

A first concrete example of a silicon nanosheet is a nanosheet comprising a silicon atom layer of “a diamond type.”

Diamond has a structure wherein regular tetrahedrons each of which has carbon atoms in the center and at the apexes thereof are linked to each other in the manner of sharing the apexes (refer to FIG. 18A). The unit lattice of a diamond structure is configured by containing four such regular tetrahedrons in a cube and has eight atoms. The atoms are located at the positions of (a) 0, 0, 0 and face-centering translation and (b) 1/4, 1/4, 1/4 and face-centering translation.

When a (111) plane of such a diamond structure is observed from the <111> orientation, it looks like carbon six-membered rings are arranged periodically. Among the six atoms constituting a carbon six-membered ring, non-neighboring three atoms are located at the positions of 0, 0, 0 and face-centering translation (namely, on a (111) plane in the expression of Miller's indices). The other three atoms are located at the positions of 1/4, 1/4, 1/4 and face-centering translation (namely, on a (444) plane in the expression of Miller's indices). That is, a carbon six-membered ring in a diamond structure has a zigzag wavy structure.

The term “a silicon atom layer of a diamond type” means that the silicon atoms are regularly arranged so as to form the structure of a (111) plane of diamond. In other words, “a silicon atom layer of a diamond type” means that Si six-membered rings are arranged two-dimensionally and periodically and, among the six silicon atoms constituting each of the Si six-membered rings, the non-neighboring three silicon atoms are located on a plane corresponding to a (111) plane of Si having a diamond structure and the other three silicon atoms are located on a plane corresponding to a (444) plane of Si having a diamond structure.

A silicon atom layer of a diamond type has various kinds of compositions in accordance with the type of a starting material and production conditions.

For example, when CaSi₂ is subjected to acid treatment with concentrated hydrochloric acid at room temperature and swelled infinitely with a surfactant, a nanosheet having a composition represented by the expression (a) below and containing a silicon atom layer of a diamond type can be obtained;
Si₆H_{3-δ}(OH)_{3+δ}(0≦δ≦3) (a).

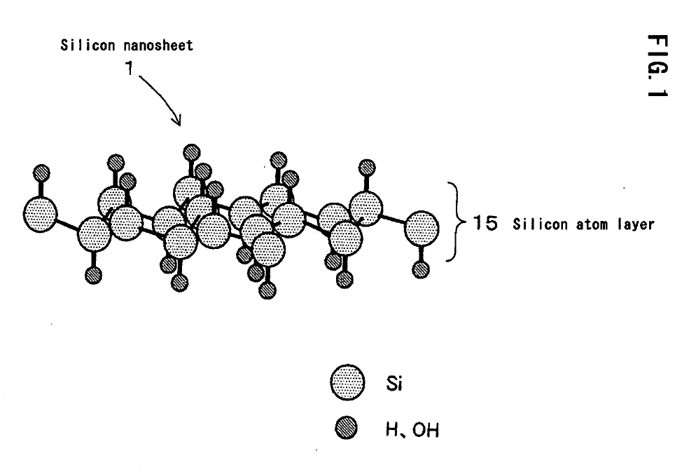

FIG. 1 shows the structure of a silicon nanosheet having a composition represented by the expression (a). In FIG. 1, a silicon nanosheet 1 is composed of a single silicon atom layer 15 of a diamond type. The silicon atom layer 15 has a zigzag wavy structure like As and P. Among the four couplings of a Si atom, three couplings are used for Si—Si bond and the remaining one coupling links to H or OH.

The surface of a silicon nanosheet having a composition represented by the expression (a) can be negatively electrified. By using the surface charge, it is possible to easily coat a substrate surface with the silicon nanosheet.

Otherwise for example, when CaSi₂ is subjected to acid treatment with concentrated hydrochloric acid at around −30° C. and swelled infinitely with a surfactant, a nanosheet having a composition represented by the expression (b) below and containing a silicon atom layer of a diamond type can be obtained;
(SiH)ₙ (b).

A silicon nanosheet having a composition represented by the expression (b) has the same structure as the silicon nanosheet 1 shown in FIG. 1 except that, in the case of the former silicon nanosheet, all of the couplings which do not contribute to the Si—Si bond link to H.

A second concrete example of a silicon nanosheet is a nanosheet comprising a silicon atom layer of “a graphite type.”

Graphite has a structure wherein planes (the c planes) formed with carbon six-membered rings are laminated in the c axis direction. The term “a silicon atom layer of a graphite type” means that silicon atoms are regularly arranged so as to form a c plane structure of graphite or a structure similar thereto. In other words, “a-silicon atom layer of a graphite type” means that: Si six-membered rings are arranged two-dimensionally and periodically; and the distance in the c axis direction between the Si six-membered rings composed of the six silicon atoms (in the direction perpendicular to the layer plane of the silicon atom layer) is narrower than the distance between a (111) plane and a (444) plane of a diamond-structured Si. That is, “a silicon atom layer of a graphite type” means that the six silicon atoms constituting a Si six-membered ring: are located on an identical plane; or form a zigzag structure wherein the amplitude thereof in the c axis direction is smaller than that of a silicon atom layer of a diamond type.

By using the after-mentioned process, it is possible to obtain a nanosheet containing a silicon atom layer wherein the angle formed by the level plane and the direction of an adjacent Si atom is in the range of 0 to 100 when viewed from the direction of the a axis of the silicon atom layer (from the direction parallel with the layer plane).

A silicon atom layer of a graphite type has various kinds of compositions in accordance with the type of a starting material and production conditions.

For example, when YbSi₂ is subjected to acid treatment under prescribed conditions and swelled infinitely with a surfactant, a nanosheet having a composition represented by the expression (c) below and containing a silicon atom layer of a graphite type can be obtained;
Si₆H_{3-δ}(OH)_{3+δ}(0≦δ≦3) (c).

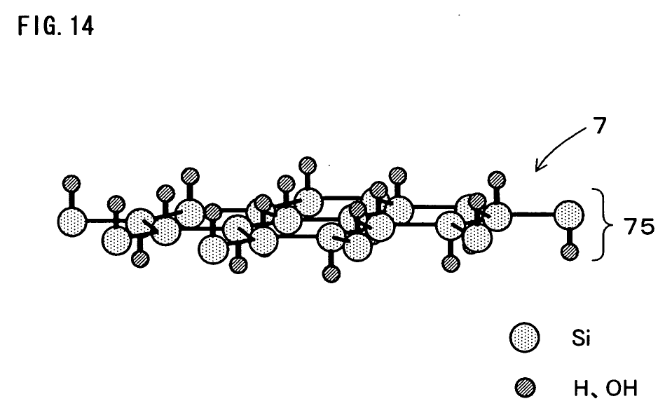

FIG. 14 shows the structure of a silicon nanosheet having a composition represented by the expression (c). In FIG. 14, a silicon nanosheet 7 is composed of a single silicon atom layer 75 of a graphite type. Among four couplings of a Si atom, three couplings are used for Si—Si bond and the remaining one coupling links to H or OH.

Meanwhile for example, when CaSi₂ is subjected to hydrothermal treatment in an amine aqueous solution, a nanosheet having a composition represented by the expression (d) below and containing a silicon atom layer of a graphite type can be obtained;
SiOₓ (0≦x≦0.5) (d).

FIG. 18B shows the structure of a silicon nanosheet having a composition represented by the expression (d). Here, the structure of diamond type silicon is also shown in FIG. 18A. A silicon nanosheet having a composition represented by the expression (d) contains a planar silicon atom layer formed with Si six-membered rings. Further, oxygen is added to parts of the silicon atom layer.

A part of a silicon atom layer may be modified with an organic modified group. In each of such various kinds of silicon atom layers as stated above, a Si atom has a coupling which does not contribute to Si—Si bond. It is estimated that such a coupling links to H, OH, O, or the like. When all or some of such couplings are modified with an organic modified group (a substituent), it is possible to impart the functions of the organic modified group (for example, the functions as a chemical catalyst and the like) to a silicon nanosheet.

As organic modified groups for example, there are an alkyl group, an alkenyl group, an alkoxy group, a carboxyl group, an acyl group, a thiol group, a sulfo group, an amino group, and others.

The most remarkable point of a silicon nanosheet according to the present invention is that: the silicon nanosheet comprises a single silicon atom layer wherein silicon atoms are arranged in a nearly planar shape; or the silicon nanosheet is formed by aggregating plural silicon atom layers in each of which silicon atoms are arranged in a nearly planar shape. That is, a silicon nanosheet according to the present invention: is a novel one which comprises a silicon atom layer having two-dimensional anisotropy; and is different from a nanosheet comprising conventional transition metal oxide such as manganese oxide, titanium oxide, and the like. A silicon nanosheet is basically non-oxide, has two-dimensional anisotropy, and hence has such excellent characteristics as stated below.

Firstly, a silicon nanosheet shows a peak in the visible light region in the measurement of a fluorescence spectrum. When a silicon nanosheet is irradiated with excitation light having a specific excitation wavelength, it emits fluorescence having specific wavelengths. More specifically, a silicon nanosheet emits fluorescence having the wavelengths of 450 to 600 nm when an excitation wavelength in the range of 400 to 500 nm is applied. Further, by optimizing the thickness of a nanosheet, the nanosheet emits fluorescence composed of three kinds of light having the peak wavelengths of 465±5 nm, 505±5 nm, and 560±5 nm, respectively when an excitation wavelength of, for example, 400 nm is applied. Here, the term “peak” means an apex of a spectrum in fluorescence spectrum measurement.

All of those wavelengths are in the visible light region and can be observed as green fluorescence. By using this phenomenon, it is possible to use a silicon nanosheet or a nanosheet solution prepared by dispersing or suspending the silicon nanosheets in a solvent for a luminous element, an indicating material, or the like.

Secondly, in the case of a silicon nanosheet, the bandgap obtained through light absorption is 3.0 eV or more.

The bandgaps of major materials used as semiconductors are 1.1135 eV in the case of Si, 1.428 eV in the case of GaAs, 3.02 eV in the case of 4H—SiC, and 5.47 eV in the case of diamond. Bulk silicon shows only a three-dimensional structure of a diamond type at normal pressures and another kind of structure thereof has not been known. For that reason, the bandgap of conventional silicon has never exceeded the value of the bulk silicon (1.1135 eV).

In contrast, a silicon nanosheet shows a larger bandgap than bulk silicon. The bandgap tends to increase as the thickness of a nanosheet reduces. By using the after-mentioned process, a silicon nanosheet having a bandgap of 3.0 eV or more can be obtained. The detailed mechanism of obtaining a wide bandgap by forming a nanosheet is not obvious but it is estimated that the planar structure, oxygen contained in a small amount, and others may presumably influence the phenomenon.

When conventionally used silicon is replaced with a material having a large bandgap and a large dielectric breakdown electric field, it is possible to reduce the thickness of each layer of an element and also to apply high concentration doping. As a consequence, it is possible to make an element having a high withstand voltage and a small on resistance. That is, by using a silicon nanosheet according to the present invention, it is possible to get rid of the trade-off between withstand voltage and on resistance, and make a low-loss high-voltage power element.

Thirdly, a silicon nanosheet has large two-dimensional shape anisotropy. Thereby, it is possible to coat the outer and inner surfaces of various kinds of substrates with nanosheets. Further, by so doing, it is possible to impart the functions intrinsic to a nanosheet to a substrate.

Fourthly, a silicon nanosheet or an aggregate of the silicon nanosheets has an extremely high surface to volume ratio. Consequently, by making use of the high surface to volume ratio, it is possible to use a silicon nanosheet or an aggregate of the silicon nanosheets for various applications (for example, a photocatalyst, a solid lubricant, and the like).

Fifthly, a silicon nanosheet exhibits high activity in the event of chemical reaction. Thereby, it is possible to use a silicon nanosheet as, for example, a negative electrode active material of a lithium secondary battery. Further, the negative electrode active material comprising a silicon nanosheet can be a high capacity material, thereby can be an ultrathin membrane electrode with the use of a small amount, and hence has the characteristics of hardly causing the downward slip from the electrode and being excellent in cyclic performance.

Sixthly, a silicon nanosheet is substantially composed of Si and hence has a high thermal conductivity. Consequently, by complexing a silicon nanosheet with, for example, resin, it is possible to increase the heat dissipation of the resin.

A silicon nanosheet according to the present invention has such excellent characteristics as stated above and hence can be used as: an electronic material constituting a semiconductor integrated circuit, a thin-film transistor or the like; a luminous element; an indicating element; or the like.

Next, a nanosheet solution according to the present invention is explained. A nanosheet solution according to the present invention is prepared by dispersing or suspending silicon nanosheets according to the present invention in a solvent.

As the solvents in which silicon nanosheets are dispersed, polar solvents such as water, alcohol, glycol, ether and the like, and a solvent comprising the mixture of those can be used.

Further, in the silicon nanosheet solution, a surfactant or an amine caused by the after-mentioned production process is contained. A surfactant or an amine has the effects of: preventing silicon nanosheets dispersing in a solvent from aggregating; and maintaining a stable dispersed state.

The concentration of silicon nanosheets in a solution is not particularly limited and can arbitrarily be selected in accordance with the application of the solution. In general, when the concentration of silicon nanosheets is too low, the operation efficiency lowers in the use for various applications and the various functions of the nanosheets lower. On the other hand, when the concentration of silicon nanosheets is too high, the silicon nanosheets may undesirably aggregate in the solution. In order to stably disperse silicon nanosheets without the deterioration of operation efficiency and functions, the concentration of silicon nanosheets is preferably 0.1 to 10 wt %, and yet preferably 0.5 to 3.0 wt %.

In order to stably disperse silicon nanosheets in a solvent, it is preferable that the width of a silicon nanosheet is as small as possible. More specifically, when the width of a silicon nanosheet is 1 μm or less, a stable colloidal solution is formed and so-called “a Tyndall phenomenon” shows up.

Next, a process for producing a nanosheet solution according to the present invention is explained.

A process for producing a nanosheet solution according to a first embodiment of the present invention includes an acid treatment step and an exfoliation step.

An acid treatment step is a step of bringing a layered silicon compound into contact with an aqueous acid solution to derive a siloxene compound.

Here, the term “a layered silicon compound” means one of a group of compounds represented by the chemical composition formula AₓSi₂ (A represents Ca and/or Yb, 0.8≦x≦1.2). A layered silicon compound has a structure wherein an A atom layer is sandwiched between layered network structures (silicon atom layers) of Si. The interlayer atom A may be either Ca or Yb, or both of Ca and Yb.

The term “a siloxene compound” means a compound obtained by bringing a layered silicon compound into contact with an aqueous acid solution, wherein acid molecules are substituted for all or some of the interlayer atoms A. Adjacent silicon atom layers are attracted to each other by the acid molecules interposed between the layers.

The term “an aqueous acid solution” means an aqueous solution containing acid such as hydrochloric acid or the like. As the solvent of an aqueous acid solution, besides water, a solvent comprising the mixture of water and alcohol such as ethanol, methanol, or the like can be used.

It is difficult to directly remove atoms (Ca or Yb) existing between layers of a layered network structure formed with Si. In the acid treatment step, therefore, acid molecules are substituted for interlayer atoms by subjecting a layered silicon compound to acid treatment and a siloxene compound is derived.

The type of acid used in the acid treatment step is not particularly limited but concentrated hydrochloric acid is particularly preferable. By using concentrated hydrochloric acid as an aqueous acid solution, it is possible to easily remove interlayer atoms without oxidizing the two-dimensional skeleton of Si.

Further, with regard to the amount of an aqueous acid solution, any amount is acceptable as long as the amount is not less than an amount which allows acid molecules to be substituted for interlayer atoms contained in a layered silicon compound. The optimum amount varies in accordance with the type of a layered silicon compound, the concentration of an aqueous acid solution, and others. Usually however, concentrated hydrochloric acid (12 N) is added by 100 ml per 1 g of a layered silicon compound.

When a layered silicon compound is subjected to acid treatment, the temperature of the aqueous acid solution influences the composition of a siloxene compound. For example, when CaSi₂ which is a kind of layered silicon compound is processed with concentrated hydrochloric acid at around room temperature, a siloxene compound (Weiss type siloxene) represented by the chemical composition formula Si₆H_{3-δ}(OH)_{3+δ}(0≦δ≦3) is obtained. In contrast for example, when CaSi₂ is processed with concentrated hydrochloric acid at around −30° C., a siloxene compound (layered polysilane) represented by the chemical composition formula (SiH)ₙ is obtained.

Further, in general, as the temperature of an aqueous acid solution rises, the two-dimensional skeleton of Si tends to be oxidized. In order to remove interlayer atoms with scarcely oxidizing the two-dimensional skeleton of Si constituting a layered silicon compound, it is preferable to lower the temperature of an aqueous acid solution as low as possible. More specifically, a desirable temperature of an aqueous acid solution is 0° C. or lower. In this case, it is possible to easily synthesize a siloxene compound scarcely containing impurities such as silica (SiO₂) and the like.

With regard to the duration of acid treatment, any duration may be accepted as long as it is sufficiently long for substituting acid molecules for the interlayer atoms of a layered silicon compound. The optimum duration: varies somewhat in accordance with the concentration and temperature of an aqueous acid solution, the amount of a layered silicon compound added to the aqueous acid solution, and others; but usually is 1 to 3 days.

Further, in order to prevent the two-dimensional skeleton of Si from oxidizing, it is preferable to apply acid treatment in an inert atmosphere such as an atmosphere of argon, N₂, or the like.

A siloxene compound obtained through the acid treatment step either may be subjected directly to the after-mentioned exfoliation step or may be washed further with an aqueous solution of acid such as hydrochloric acid or the like (a first washing step). When the siloxene compound is further washed with acid after the acid treatment, salt (for example, calcium salt) as a by-product can be removed and hence a nanosheet solution of a higher purity can be produced.

Further, the siloxene compound may be washed further with an organic solvent after washed with an aqueous acid solution (a second washing step). When the siloxene compound is further washed with an organic solvent, excessive acid such as hydrochloric acid used in the first washing step can be removed and hence a nanosheet solution of a far higher purity can be produced. As organic solvents used for washing, for example, there are acetone, ethanol, methanol, tetrahydrofuran, and others.

Further, in a siloxene compound obtained by subjecting a layered silicon compound to acid treatment, some of the Si atoms are hydrogenated and/or hydroxylated. When the siloxene compound is further dispersed in water and agitated at room temperature, it is possible to add oxygen to some of the Si atoms. Otherwise, when the siloxene compound is further refluxed in an aqueous solution containing iodide RI (R represents an alkyl group, an alkenyl group, an alkoxy group, a carboxyl group, an acyl group, a thiol group, a sulfo group, an amino group, or the like) including methyl iodide (CH₃I) or the like, it is possible to add an organic modified group to some of the Si atoms. An oxidized, hydrogenated, or hydroxylated silicon nanosheet or a silicon nanosheet to which an organic modified group is added can be produced after the after-mentioned exfoliation step in accordance with the kinds of processes applied to a siloxene compound.

An exfoliation step is a step of adding a siloxene compound into a solvent containing a surfactant, shaking the mixture, and peeling off the siloxene compound. By so doing, the siloxene compound swells infinitely and a single layered or multilayered nanosheet wherein silicon atoms are arranged nearly planarly and periodically can be obtained.

As surfactants, there are an anionic surfactant, a cationic surfactant, a neutral surfactant, and others. Any of those surfactants may be used in the present invention.

As the anionic surfactants, there are, for example, sodium dodecyl sulfate (SDS), sodium perfluorooctanoate (SPFO), sodium alkylbenzenesulfonate such as sodium dodecylbenzenesulfonate or the like, sodium stearate, and others.

As the cationic surfactants, there are, for example, tetrabutyl ammonium hydroxide (TBAOH), tetramethylammonium ((CH₃)₄NOH), tetraethylammonium ((C₂H₅)₄NOH), tetrapropyl ammonium ((C₃H₇)₄NOH), n-ethylamine (C₂H₅NH₂), n-propylamine (C₃H₇NH₂), and others.

As the neutral surfactants, there are, for example, P-1,2,3 (block copolymer, HO(CH₂CH₂O)₂₀(CH₂CH(CH₃)O)₇₀(CH₂CH₂0)₂₀H), and others.

With regard to a solvent to which a surfactant is added, any solvent may be used as long as it can dissolve the surfactant. As the concrete solvents, water, ethanol, ethylene glycol, and others can be used.

The concentration of a surfactant in a solution affects the thickness of a silicon nanosheet. A. surfactant has the functions of intruding between the layers of a siloxene compound, expanding the distance between the silicon atom layers, and facilitating the exfoliation. In general, as the concentration of a surfactant relatively increases, the surfactant tends to be substituted for all of the acid molecules and the constituent ions thereof intruding between the layers and hence it becomes easier to peel off the silicon atom layers and form single layers. On the other hand, when the concentration of a surfactant relatively decreases, a multilayered nanosheet tends to be obtained. Here, a multilayered nanosheet may sometimes be formed also by aggregating nanosheets which are once peeled off to form single layers in a solution.

The optimum concentration: varies in accordance with the structure and composition of a nanosheet to be produced, the type of the surfactant, and others; but is usually in the range of 0.01 to 1.0 mol/dm³.

With regard to the amount of a surfactant solution, any amount is acceptable as long as the amount is sufficient to efficiently insert the surfactant between the layers of a siloxene compound. The optimum amount varies in accordance with the concentration of a surfactant, the amount of the siloxene compound added to the solution, and others, but usually a surfactant solution containing a surfactant in the amount corresponding to the amount one to two times the siloxene compound by mol is added.

Further, it is preferable that a surfactant solution is acidic. In the case where a siloxene compound is added to a surfactant solution and shaken, when the pH of the solution increases, the two-dimensional skeleton of Si is oxidized and silica tends to form. In contrast, when the solution is acidic, the oxidation of the two-dimensional skeleton of Si can be suppressed. Specifically, the pH of a surfactant solution is preferably 5 or lower.

For example, when an anionic surfactant or a neutral surfactant is used as a surfactant, it is preferable to add acid such as hydrochloric acid, nitric acid, sulfuric acid, or acetic acid in a solution and adjust pH to 5 or lower. In particular, in the case of an anionic surfactant, a siloxene compound is easily peeled off and moreover silica is more easily and surely prevented from forming by adjusting the pH of a solution, and hence the anionic surfactant is particularly suitable for a surfactant used in the exfoliation step.

On the other hand, when a cationic surfactant is used as a surfactant, acid is formed during the reaction process and hence it sometimes happens that the exfoliation of silicon atom layers resultantly proceeds in an acidic region. In such a case, even when pH is not particularly adjusted in an acidic region, it is possible to peel off a siloxene compound without oxidizing the two-dimensional skeleton of Si.

After a siloxene compound is added to a surfactant solution, the solution is shaken mechanically or with supersonic waves. The strength and time of the shaking influence the thickness and width of a nanosheet. In general, as the strength of shaking increases and/or the time thereof also increases, the thickness of a nanosheet tends to reduce (namely, the probability of obtaining a single layered nanosheet increases) and/or the width of the nanosheet tends to reduce. The optimum shaking time varies in accordance with a shaking process, a shaking strength, and others, but usually is 3 to 7 days.

For example, in order to peel off a siloxene compound to a thickness of 10 nm or less, it is preferable to: add a surfactant solution of 100 to 1,000 mL having the surfactant concentration of 0.01 to 1.0 mol/dm³ to a siloxene compound of 1 g; and shake the solution for 3 to 7 days under the condition of 100 to 250 rpm.

Otherwise for example, in order to peel off a siloxene compound to form single layers, it is preferable to add a surfactant solution of 500 to 1,000 mL having the surfactant concentration of 0.5 to 0.8 mol/dm³ to a siloxene compound of 1 g; and shake the solution for 5 to 10 days under the condition of 100 to 250 rpm.

When a siloxene compound is added to a surfactant solution and the mixture is shaken under prescribed conditions, the siloxene compound peels off and a nanosheet solution containing silicon nanosheets is obtained. For example, when Weiss type siloxene Si₆H₃(OH)₃ is added to a surfactant solution and the mixture is shaken, a suspended nanosheet solution of pale yellow-green color is obtained.

Here, it sometimes happens that solid materials (an unreacted siloxene compound, a coarse nanosheet, and others) may settle in a solution under some shaking conditions. In such a case, the solid materials are removed by centrifugal separation or the like. A nanosheet solution after solid materials have been removed is extremely stable and shows light scattering (a Tyndall phenomenon) intrinsic to colloid. Further, when a nanosheet solution is subjected to centrifugal separation, by optimizing the separation conditions, most of multilayered nanosheets are removed from the solution and a nanosheet solution having a high content of single layered nanosheets can be obtained.

The structure and composition of a silicon nanosheet contained in a thus obtained nanosheet solution vary in accordance with the kind of the layered silicon compound and the production conditions. For example, when CaSi₂ is used as a layered silicon compound and subjected to acid treatment and exfoliation, a nanosheet containing a silicon atom layer of a diamond type is obtained.

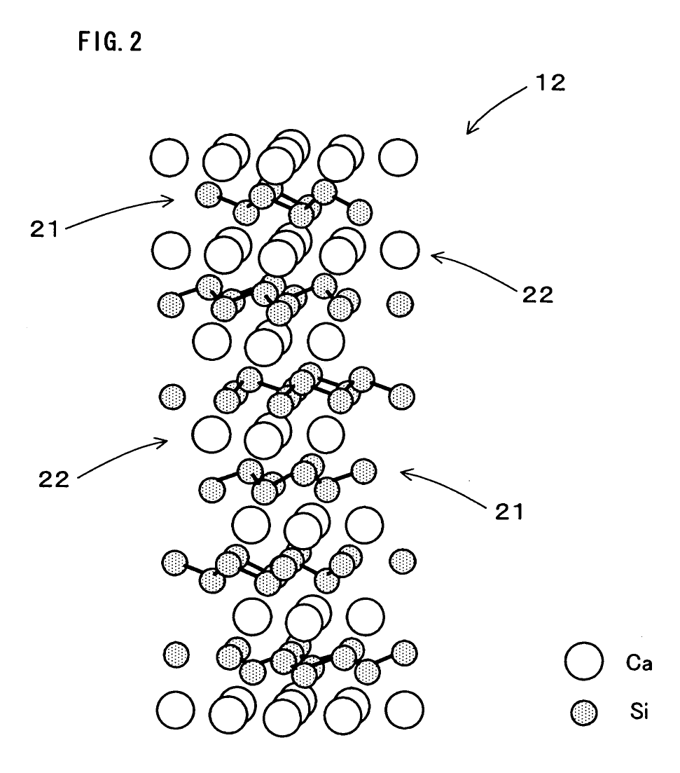

A crystal structure of CaSi₂ which is a kind of layered silicon compound is shown in FIG. 2. In FIG. 2, CaSi₂ (a layered silicon compound 12) has a structure wherein a Ca atom layer 22 is sandwiched between layers of a layered network structure 21 of Si.

CaSi₂ is one of typical Zintl phases and the formal charge thereof is represented by Ca²⁺ (Si⁻)₂. Here, Si⁻ has an electron structure equivalent to phosphorus which is one of the fifth family elements in the periodic law of elements and forms a layered network structure similar to arsenic and black phosphorus. That is, CaSi₂ is viewed as being a layered crystal wherein a Ca atom layer 22 is inserted between (111) planes of Si having a diamond structure (a layered network structure 21 of Si).

When such a layered silicon compound is processed with an aqueous acid solution, the interlayer atoms are removed and acid molecules intrude between the layers. The reaction caused when CaSi₂ as a kind of layered silicon compound is subjected to acid treatment with an HCl aqueous solution is shown with the expression (1) below;
3CaSi₂+7HCl→Si₆H₃(OH)₃.HCl+3CaCl₂+3H₂ (1)

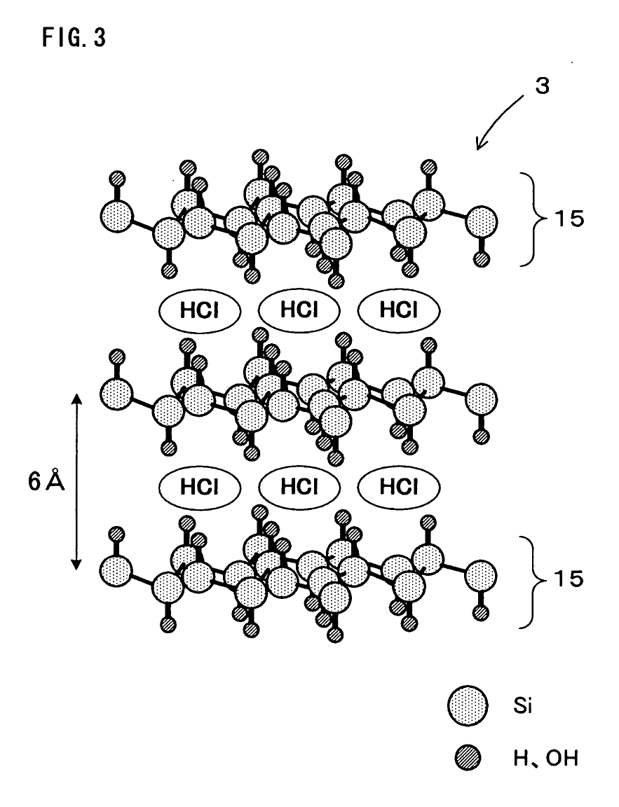

The crystal structure of a siloxene compound obtained through the reaction represented by the expression (1) is shown in FIG. 3. When CaSi₂ is processed with an HCl aqueous solution, Ca between the layers is removed and Weiss type siloxene (Si₆H₃(OH)₃.HCl) which is a kind of siloxene compound is derived. Weiss type siloxene (a siloxene compound 3) has a structure wherein HCl molecules are inserted between silicon atom layers 15 as shown in FIG. 3. The silicon atom layers 15 are attracted to each other through the HCl. The distance between the silicon atom layers 15 is about 6 Å.

A siloxene compound obtained through acid treatment is: if needed, subjected to washing with an aqueous acid solution (a first washing step), washing with an organic solvent (a second washing step), oxidation, modification with an organic modified group, and others; and thereafter added to a surfactant solution of a prescribed concentration and a prescribed amount. When a siloxene compound is added to a surfactant solution, the surfactant intrudes between layers of the siloxene compound and the distance between the layers expands.

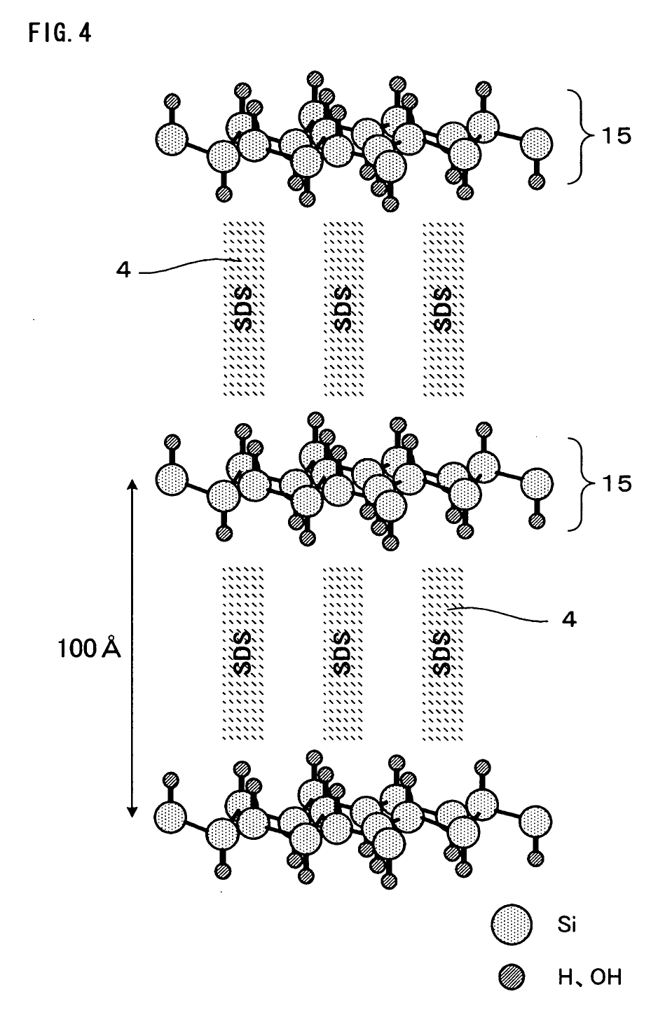

The crystal structure of a compound obtained by adding a siloxene compound 3 shown in FIG. 3 to a sodium dodecyl sulfate (SDS) solution is shown in FIG. 4. As shown in FIG. 4, when the siloxene compound 3 is added to a solution containing a surfactant (SDS) 4, HCl molecules or the constituent ions thereof inserted between silicon atom layers 15 are replaced with bulky guest molecules (SDS). As a result, the distance between the silicon atom layers 15 expands to about 100 Å.

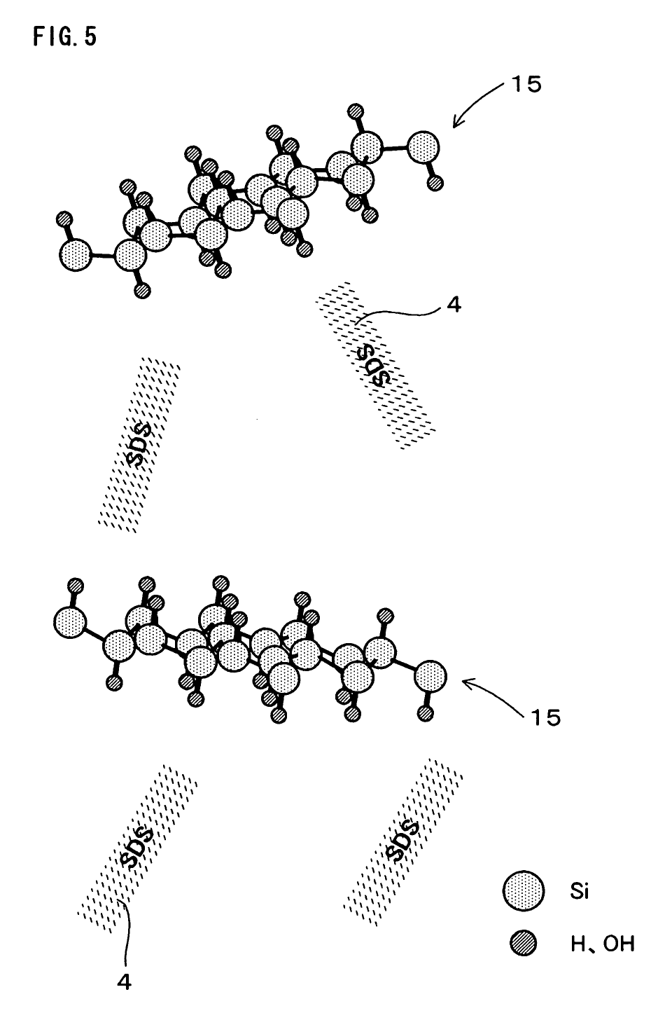

When the surfactant 4 is inserted between the silicon atom layers 15, the bonding force between the silicon atom layers 15 weakens. Thereby, when the solution is shaken, the constraining force between the silicon atom layers 15 is cut and the silicon atom layers 15 peel off as shown in FIG. 5. Then, by optimizing the conditions in the exfoliation step, it is possible to peel off the silicon atom layers 15 to form single layers. By further optimizing the conditions in the exfoliation step, it is possible to suppress the oxidation of a Si skeleton when the silicon atom layers 15 are peeled off. As a result, a silicon nanosheet substantially composed of Si is obtained.

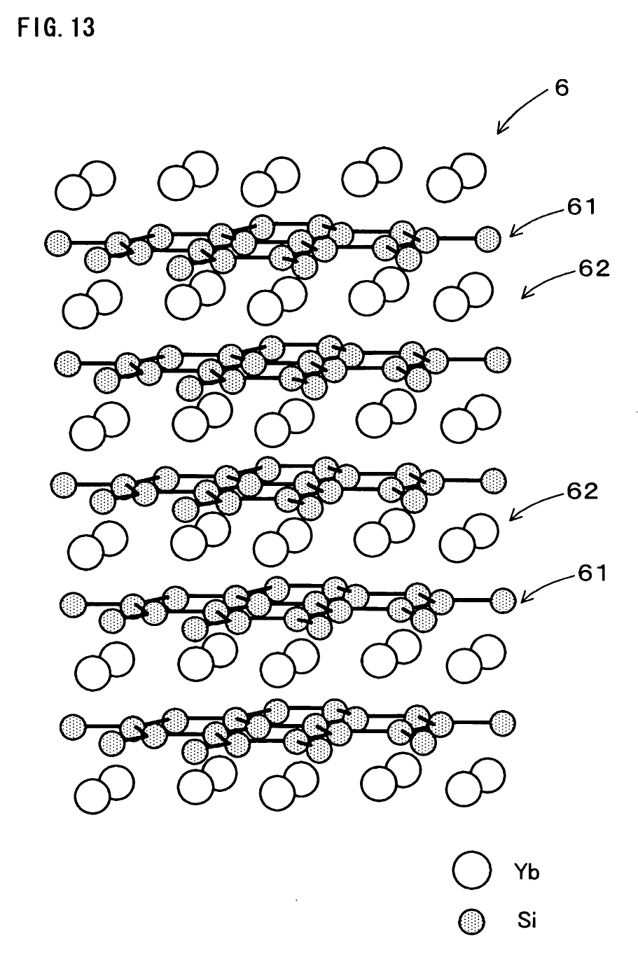

The crystal structure of YbSi₂ which is a kind of layered silicon compound is shown in FIG. 13. In FIG. 13, YbSi₂ (a layered silicon compound 6) has a structure wherein a Yb atom layer 62 is sandwiched between layers of a layered network structure 61 of Si and forms an AlB₂-type layered disilicide structure. In YbSi₂, Si forms a flat layered network structure 61 similar to graphite.

When YbSi₂ is used as a layered silicon compound too, a siloxene compound is derived through acid treatment likewise. Successively, when the obtained siloxene compound is added to a surfactant solution and the solution is shaken, a silicon nanosheet 7 containing a silicon atom layer 75 of a graphite type is obtained as shown in FIG. 14.

Silicon nanosheets according to the present invention are contained in a thus obtained nanosheet solution and hence, by making use of the characteristics, the nanosheet solution can be used for various kinds of applications as shown below.

(1) The silicon nanosheet, as stated above, emits fluorescence of specific wavelengths with a specific excitation wavelength. Hence, the nanosheet solution can be used as it is for a liquid fluorescent agent and the like.

(2) When a substrate surface is coated with the nanosheet solution or a substrate is dipped into the nanosheet solution, it is possible to coat the substrate surface with a nanosheet. Since a nanosheet solution in a colloidal state is excellent in film-formability and casting properties in particular, it is possible to uniformly coat a substrate surface with a nanosheet even when the substrate has a complicated shape.

(3) When a substrate surface coated with the nanosheet is heated under appropriate conditions, hydrogen, a hydroxyl and others are separated and a silicon crystal or a silicon membrane can be formed on the substrate surface. That is, by using the nanosheet solution, it is possible to obtain a silicon crystal or a silicon membrane with ease without employing a crushing means, a melting means, a sputtering means, a vapor deposition means, or the like. The obtained silicon crystal and membrane can be used for an electronic material for the production of: a semiconductor integrated circuit, a thin-film transistor, or the like; a luminous element; an indicating element; or the like.

(4) When a substrate surface is coated with the nanosheet and thereafter the coated substrate is heated in an oxidizing atmosphere, it is possible to uniformly coat the substrate surface with a very thin silica (SiO₂) membrane.

(5) Whereas silicon obtained by a chemical vapor deposition process (a CVD process) or the like is generally spherical, a flaky silicon nanosheet is obtained by a production process according to the present invention. The nanosheet has a very high surface to volume ratio and exhibits high catalytic performance in the event of chemical reaction, and hence a nanosheet solution in which the nanosheets disperse can be used as various kinds of catalysts.

Next, a process for producing a nanosheet solution according to a second embodiment of the present invention is explained.

A process for producing a nanosheet solution according to the present embodiment includes a hydrothermal treatment step and a separation step.

The hydrothermal treatment step is a step of dispersing a layered silicon compound in a solvent comprising the mixture of an amine having 3 or more carbon atoms and water and applying hydrothermal treatment.

In the present invention, the term “an amine” means an organic compound having an amino group (—NH₂) (a first amine). The amine may be an amine having one amino group (a univalent amine) or an amine having two or more amino groups (a multivalent amine). In particular, a univalent amine has the large effect of peeling off silicon atom layers to form single layers and hence is suitable for an amine used in a hydrothermal treatment step.

Further, it is preferable that an amine has 3 or more carbon atoms. Furthermore, it is preferable that an amine is a straight-chain type. When an amine of molecules having a relatively large number of carbon atoms and/or molecules of a straight-chain type (namely somewhat bulky molecules) is used, the amine is inserted between silicon atom layers, thereby the distance between the silicon atom layers expands, and the silicon atom layers is easily peeled off to form single layers.

As the concrete amines, there are propylamine (C₃H₇NH₂), butylamine (C₄H₉NH₂), pentylamine (C₅H₁₁NH₂), hexylamine (C₆H₁₃NH₂), peptylamine (C₇H₁₅NH₂), octylamine (C₈H₁₇NH₂), and others.

Here, with regard to a layered silicon compound, the production process thereof is the same as the production process according to the first embodiment and therefore the explanations are omitted.

With regard to the concentration of an amine contained in a mixed solvent, any concentration is acceptable as long as it is a concentration which allows the amine to be efficiently substituted for the interlayer atoms contained in a layered silicon compound. In general, as an amine concentration increases, the amine is more easily substituted for interlayer atoms. Meanwhile, when an amine concentration is too high, a lamella structure wherein a silicon layer is linked to the amine is undesirably formed.

In order to efficiently obtain a nanosheet, an amine concentration in a mixed solvent is preferably 10 to 30 vol %, and yet preferably 15 to 25 vol %.

With regard to the amount of a mixed solvent used in a hydrothermal treatment step, any amount is acceptable as long as it is an amount which allows the amine to be substituted for the interlayer atoms contained in a layered silicon compound. The optimum amount varies in accordance with the kind of a layered silicon compound, the concentration of a mixed solvent, and others, but is usually 50 to 200 mL per 1 g of a layered silicon compound.

A preferable hydrothermal treatment temperature is 120° C. to 180° C. When the hydrothermal treatment temperature is lower than 120° C., the exfoliation of silicon atom layers does not proceed within a practical time. On the other hand, when the hydrothermal treatment temperature exceeds 180° C., a sheet is likely to decompose.

With regard to hydrothermal treatment duration, the optimum duration is selected in accordance with a hydrothermal treatment temperature. In general, when hydrothermal treatment duration is short, the exfoliation of silicon atom layers is insufficient. On the other hand, superfluous hydrothermal treatment has no practical benefits. For example, when a hydrothermal treatment temperature is 120° C., a nanosheet can be obtained through hydrothermal treatment for 3 days or longer.

The separation step is a step of separating unreacted materials from a mixed solvent after hydrothermal treatment. By separating unreacted materials from a mixed solvent, a nanosheet solution according to the present invention is obtained. A process for separating unreacted materials is not particularly limited but centrifugal separation is preferable.

By using a process according to the present embodiment, a nanosheet solution containing silicon nanosheets having various widths or a nanosheet solution wherein single-layered nanosheets and multilayered nanosheets coexist is obtained. When the obtained nanosheet solution is subjected to centrifugal separation under appropriate conditions, coarse nanosheets are separated and a nanosheet solution of a colloidal state is obtained. Also, by optimizing separation conditions, a nanosheet solution containing a larger amount of single-layered nanosheets is obtained.

The detailed mechanism wherein a silicon nanosheet is obtained by the process according to the present embodiment is not obvious but it is estimated that the reason why a silicon nanosheet is obtained is that bulky amine molecules are substituted for the interlayer atoms of a layered silicon compound through hydrothermal treatment and the silicon atom layers swell infinitely. Further, it is estimated that the reason why a multilayered nanosheet is obtained by the process according to the present embodiment is that the nanosheets which have once been peeled off to form single layers by hydrothermal treatment are reaggregated in a solution.

Furthermore, in the process according to the present embodiment, by changing the kind of a used layered silicon compound and conditions, silicon nanosheets having various structures are obtained. For example, when CaSi₂ is used as a layered silicon compound and subjected to hydrothermal treatment in a mixed solvent containing a straight-chain univalent amine, a nanosheet containing a silicon atom layer of a graphite type can be synthesized.

Next, a nanosheet-containing composite according to the present invention and a process for producing the composite are explained.

A nanosheet-containing composite according to the present invention is configured by having a silicon nanosheet according to the present invention on the surface and/or in the interior of a substrate.

Here, the term “a substrate” means a material other than a silicon nanosheet, and the kind and the shape of the material make no matter. That is, the kind of the substrate may be any of glass, ceramics, metal, resin and others. Further, the shape of the substrate may be any of a plate, a bar, a pipe, a sheet, a porous body, powder, and others.

The term “having a silicon nanosheet on the surface of a substrate” means that all or a part of the surface (including the inner surface) of a substrate is coated with a silicon nanosheet. The substrate surface may be coated with either a single-layered silicon nanosheet or a two-or-more-layered silicon nanosheet.

The term “having a silicon nanosheet in the interior of a substrate” means that silicon nanosheets disperse in the interior of a substrate. The nanosheets may uniformly disperse in an overall substrate or the content of nanosheets may vary according to the location.

A nanosheet-containing composite according to the present invention can be produced by a variety of processes. Specifically, there are the following processes.

A first process is a process of coating a substrate surface directly with a nanosheet solution or dipping a substrate directly into a nanosheet solution.

A nanosheet is likely to be charged negatively in a solution. In such a case, it is preferable to use a material which is charged positively in a solution (for example, polydialyldimethylammonium (PDDA), polyethyleneimine (PEI), or the like) as the substrate. When a material which is likely to be charged positively is used as the substrate, it is possible to easily form a nanosheet membrane on the substrate surface due to the electrical interaction between the substrate and the nanosheet solution merely by coating the substrate with a nanosheet solution or dipping the substrate into a nanosheet solution.

A second process is a process of making a substrate surface alternately adsorb a nanosheet and a material having an electric charge of a polarity opposite that of the nanosheet (hereunder referred to as “a second material”) in a solution.

When a substrate is a material which has no electric charge or has electric charge of the same polarity as that of a nanosheet (for example, poly(sodium4-styrenesulfonate) (—CH₂CH(C₆H₄SO₃Na)ₙ—) or the like) in a solution, a uniform nanosheet membrane is hardly formed even when the substrate surface is directly coated with a nanosheet solution. In contrast, it is possible to easily form a nanosheet membrane on the substrate surface due to the electrical interaction between the second material and the nanosheet solution by coating a substrate surface with the second material beforehand.

As stated above, a nanosheet is likely to be charged negatively in a solution. In such a case, a substrate surface is coated beforehand with a material which is positively charged in a solution. As concrete materials which are positively charged, there are cationic resins such as polydiallyl dimethyl ammoniumchloride (PDADMAC), polyethyleneimine (PEI), polyallylamine hydrochloride (PAH), and others. A substrate surface may be coated with one layer of the second material and one layer of the noanosheet in this order or the second material and the nanosheet may be adsorbed alternately to form plural layers.

Further, when a substrate is a material having electric charge of a polarity opposite that of a nanosheet in a solution, as stated above, a nanosheet membrane can be formed merely by coating the substrate surface with a nanosheet solution. However, the thickness of a nanosheet membrane is almost determined by the thickness of a nanosheet in a solution and it is difficult to form a thick membrane. In contrast, it is possible to increase the thickness of a nanosheet membrane nearly in proportion to the repetition rate of alternate adsorption without regard to the existence or the polarity of electric charge on the substrate surface by making a substrate surface adsorb a nanosheet and the second material alternately.

A third process is a process of mixing a nanosheet solution or nanosheets with a solution containing a substrate or melt of a substrate; and solidifying the mixture.

The third process does not particularly limit the material kind of a substrate but is suitable particularly for a process of dispersing nanosheets in the interior of a resin material. By using the process, it is possible to produce, for example, a resin film wherein silicon nanosheets disperse. A silicon nanosheet is excellent in thermal conductivity and hence a resin film wherein silicon nanosheets disperse has both electrical insulating properties and thermal conductivity. Consequently, it can be used as, for example, an electrical insulating material and the like having high heat dissipation in an electronic part and the like.

A nanosheet-containing composite obtained by the aforementioned process can be used for various applications as it is. Further, it may be subjected to heat treatment under prescribed conditions if the material of a substrate allows the heat treatment.

For example, by applying a nanosheet on the surface or in the interior of a substrate and thereafter heating the substrate at 800° C. to 1,000° C. in an inert atmosphere, it is possible to remove hydrogen and a hydroxyl contained in the silicon nanosheet. As a result, it is possible to form a crystal or a membrane substantially composed of only Si atoms on the surface or in the interior of the substrate.

Further for example, it is possible to form a crystal or a membrane of silica (SiO₂) on the surface or in the interior of the substrate by applying a nanosheet on the surface or in the interior of a substrate and thereafter heating the substrate at 500° C. to 1,000° C. in an oxidizing atmosphere.

Next, a nanosheet aggregate according to the present invention and a process for producing it are explained.

A nanosheet aggregate according to the present invention is obtained by aggregating nanosheets according to the present invention.

In a nanosheet solution, silicon nanosheets are in the state of dispersing or suspending in a liquid (a solvent). As processes for aggregating the nanosheets, there are the following processes;

(1) a process of adjusting the pH of a nanosheet solution to 7 to 5 and aggregating nanosheets (so called “a sol-gel process”),

(2) a process of controlling the concentration of an electrolyte in a nanosheet solution in the range of 1 to 10 moles and aggregating nanosheets,

(3) a process of heating or freeze-drying a nanosheet solution and thereby removing a solvent in the solution, and others.

Since a silicon nanosheet has a very large two-dimensional anisotropy, a nanosheet aggregate obtained by aggregating the silicon nanosheets comprises fine particles (0.1 to 3 μm in average diameter) and has a high surface to volume ratio (50 to 200 m²/g). Consequently, a nanosheet aggregate can be used as various kinds of carriers, an absorbent, and others. Further, by using a nanosheet aggregate as a negative electrode active material of a lithium secondary battery, it is possible to configure the lithium secondary battery having a large capacity and being excellent in cyclic performance.

### EXAMPLES

### Example 1

1. Derivation of Weiss Type Siloxene

A nanosheet solution was produced by using CaSi₂ (refer to FIG. 2) as a layered silicon compound. Firstly, CaSi₂ powder was brought into contact with concentrated hydrochloric acid (12 N) at a rate of 100 cm³ of the latter to 1 g of the former and was reacted at 0° C. in an argon atmosphere (an acid treatment step). After the reaction for 8 hours, Weiss type siloxene (Si₆H₃(OH)₃.HCl, refer to FIG. 3) of yellowish green was obtained.

Successively, the powder was filtered and thereafter washed with concentrated hydrochloric acid cooled to 0° C. in an argon atmosphere, and thus CaCl₂ as a by-product was removed (a first washing step). Thereafter, the powder was further washed with acetone (a second washing step).

2. Exfoliation of Weiss Type Siloxene

Next, Weiss type siloxene of 0.2 g was added to a sodium dodecyl sulfate (SDS) aqueous solution having the concentration of 0.1 mol/dm³ and a pH of 5 or less which was adjusted with hydrochloric acid. By so doing, the HCl having intruded between silicon atom layers of the Weiss type siloxene was replaced with the SDS (the surfactant) and the distance between the silicon atom layers expanded from about 6 Å to about 100 Å (refer to FIGS. 3 and 4).

Successively, shaking was applied at the rate of about 100 rpm for 10 days with a shaker (made by As One Corporation) (an exfoliation step) and the Weiss type siloxene containing the SDS was peeled off to a thickness of 10 nm or less, namely a thickness nearly equal to the thickness of a single layered silicon atom layer (refer to FIG. 5). Thereby, a nanosheet solution wherein silicon nanosheets 1 having the structure shown in FIG. 1 dispersed was obtained.

In the present example, since SDS which was an anionic surfactant was used as a surfactant in particular, it was possible to replace Cl⁻ ions among the HCl molecules which had intruded between silicon atom layers of a siloxene compound with the surfactant. Then, since the Cl⁻ ions were replaced with the anionic surfactant and shaking was applied under strong acidic conditions of pH 5 or lower, it was possible to easily peel off the siloxene compound to a thickness of 10 nm or less.

3. Evaluation

It was observed that, when the nanosheet solution was put into a beaker and irradiated with a light from one side, a Tyndall phenomenon intrinsic to a colloidal solution appeared. Therefore, it was understood that the nanosheet solution obtained in the present example was a colloidal solution.

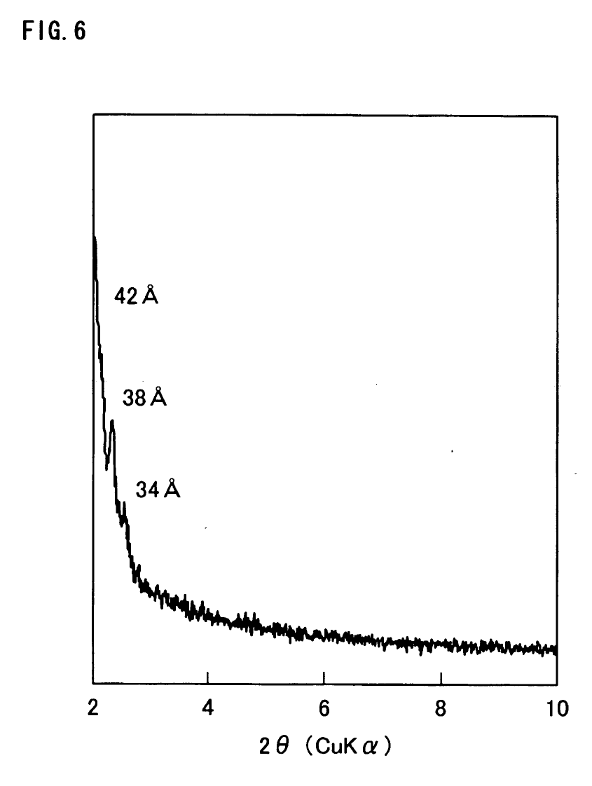

Further, the nanosheet solution was subjected to X ray diffractometry and the distance between silicon atom layers was measured. The result is shown in FIG. 6. From FIG. 6, it was understood that most of the silicon atom layers dispersed in the solvent with a space of 100 Å or more, namely most of the silicon nanosheets were composed of single layered silicon atom layers.

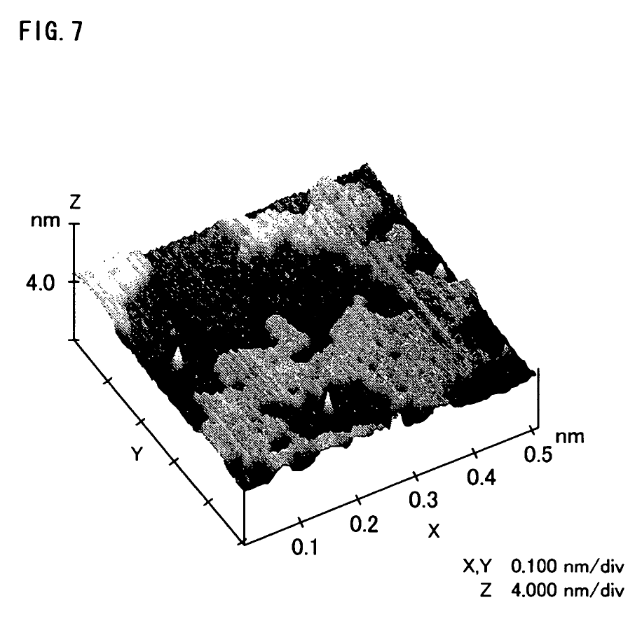

Next, the nanosheet solution was dropped on a mica, dried, and thereafter observed with an atomic force microscope (AFM) (D3100, made by Veeco Instruments Inc.). The result is shown in FIG. 7. From FIG. 7, it was understood that the thickness of the nanosheet was 0.7 to 0.8 nm and the width thereof was around 100 nm.

Next, the nanosheet solution was dropped on a copper mesh for observation with a transmission electron microscope (TEM) (made by JEOL Ltd.), dried, and thereafter observed with the TEM. As a result, it was found that the concentration was uniform in a silicon nanosheet and the thickness of the silicon nanosheet was very uniform.

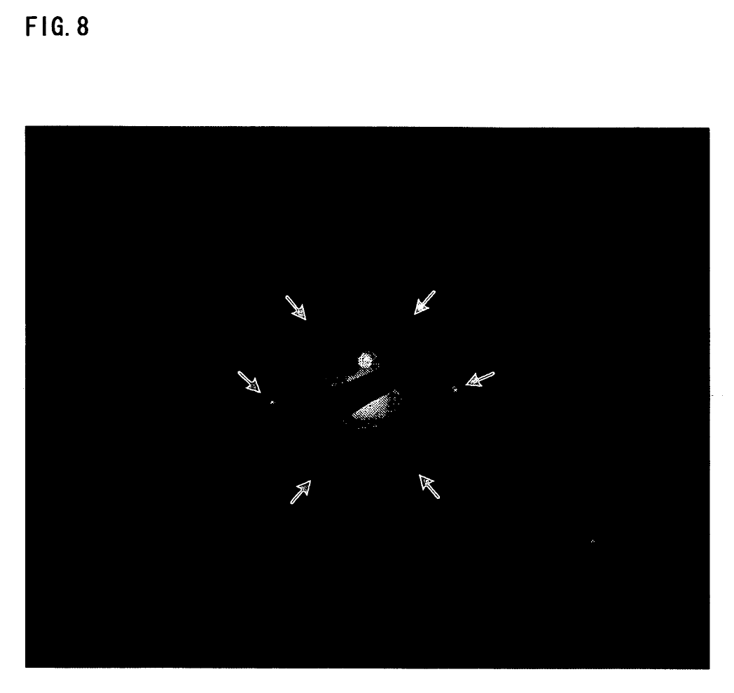

Next, an electron diffraction pattern of the silicon nanosheet was measured with a TEM apparatus (made by JEOL Ltd.). The result is shown in FIG. 8.

As shown in FIG. 8, it was confirmed that the silicon nanosheet showed a diffraction pattern which was formed when a silicon nanosheet was irradiated with a beam from the (111) direction of a crystal having a face centered cubic (FCC) lattice structure. That is, it was understood that the silicon nanosheet according to the present example was a nanosheet obtained by peeling off a layered silicon compound comprising CaSi₂ which was used as the starting material to form single layers (monomolecular layers) in the state where the (111) plane of Si in the layered silicon compound was maintained as it was.

Here, in FIG. 8, the white dots show the (220) planes of a face centered cubic (FCC) lattice and, since the dots are hardly visible in the figure, the dots are indicated with the arrows for convenience. As shown in FIG. 8, the dots were observed at the positions of the apexes of a nearly regular hexagon.

In the present example as stated above, a silicon nanosheet having an uniform thickness of 0.7 to 0.8 nm and comprising the same structure as the (111) plane of silicon, wherein the interior of the plane was composed of a monocrystal, could be obtained. In the obtained silicon nanosheet, as shown in FIG. 1, a part of the hydrogen of Weiss type siloxene (Si₆H₃(OH)₃.HCl) was hydroxylated. Taking it into consideration that a small amount of gas was generated in the exfoliation step, it was estimated that the hydroxylation was caused by such reaction between the Weiss type siloxene and water in the exfoliation step as represented by, for example, the expression (2) below,
Si₆H₃(OH)₃+δH₂O→Si₆H_{3-δ}(OH)_{3+δ}+δH_{2⇑}(0≦δ≦3) (2).

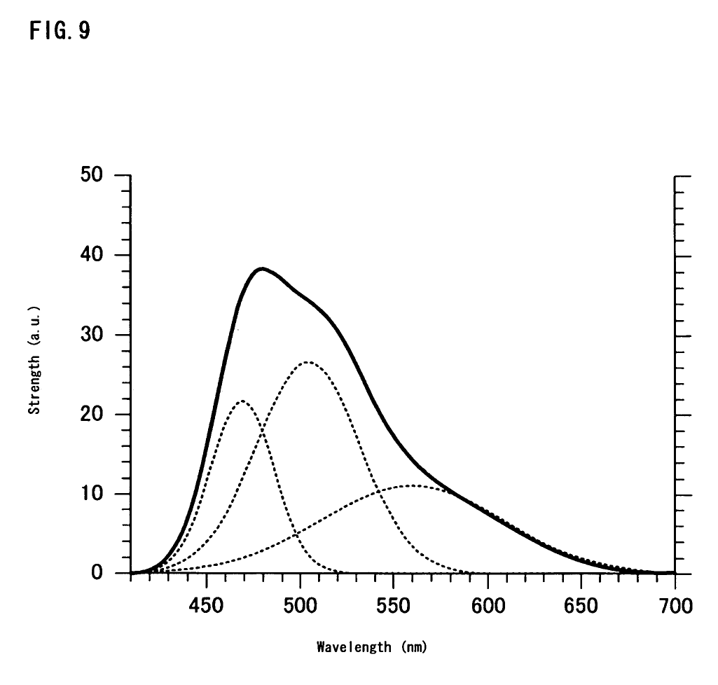

Next, the fluorescence spectrum of the nanosheet solution was measured with a fluorescence spectrophotometer (FP-6600, made by JASCO Corporation). A fluorescence spectrum when the excitation wavelength was set at 400 nm and the solid concentration (the concentration of silicon nanosheets) was set at 0.5% by weight is shown in FIG. 9. In FIG. 9, the horizontal axis represents a wavelength (nm) and the vertical axis represents a strength. Further, in FIG. 9, the measurement result of the fluorescence spectrum is shown with the solid line and the waveforms obtained by the waveform separation of the measurement result (the solid line) are shown with the dotted lines.

From FIG. 9, it was understood that:
(1) when a silicon nanosheet according to the present example was irradiated with light of the excitation wavelength of 400 nm, a fluorescence having the wavelengths of 450 to 600 nm was emitted; and
(2) the fluorescence spectrum could be separated into three types of waveforms having the peak wavelengths of 465±5 nm, 505±5 nm, and 560±5 nm, respectively.

Further, although it is not shown in the figure, when the concentration of the solid content in a nanosheet solution was diluted to 0.05% by weight, the strength of the peak of the waveform having the peak wavelength of 465±5 nm increased. The increase of the peak strength can be explained as the quantum size effect of the silicon nanosheet.

As stated above, a silicon nanosheet according to the present example emits a green fluorescence comprising three types of lights having peaks in a visible light region. By making use of the phenomenon, such a silicon nanosheet and a nanosheet solution wherein the silicon nanosheets are dispersed or suspended can be used for an indicating material and others.

### Example 2

Following the same procedure as described in the item 1 of Example 1, Weiss type siloxene (Si₆H₃(OH)₃.HCl) was produced. Successively, the Weiss type siloxene of 0.2 g was added to a tetrabutyl ammonium (TBAOH, a cationic surfactant) aqueous solution. In this case, the concentration of the tetrabutyl ammonium aqueous solution was set at the same mol concentration as the Cl in the Weiss type siloxene (Si₆H₃(OH)₃.HCl), namely 0.1 mol/dm³. The solution was shaken for 10 days at the rate of about 100 rpm with a shaker (made by As One Corporation) and resultantly a nanosheet solution was obtained.

In the case of the nanosheet solution obtained in the present example too, in the same way as Example 1, it was confirmed that silicon nanosheets nearly comprising single layered silicon atom layers dispersed in a solvent and had a peak in the visible light region in the measurement of a fluorescence spectrum.

### Example 3

1. Production of a Nanosheet-Containing Composite

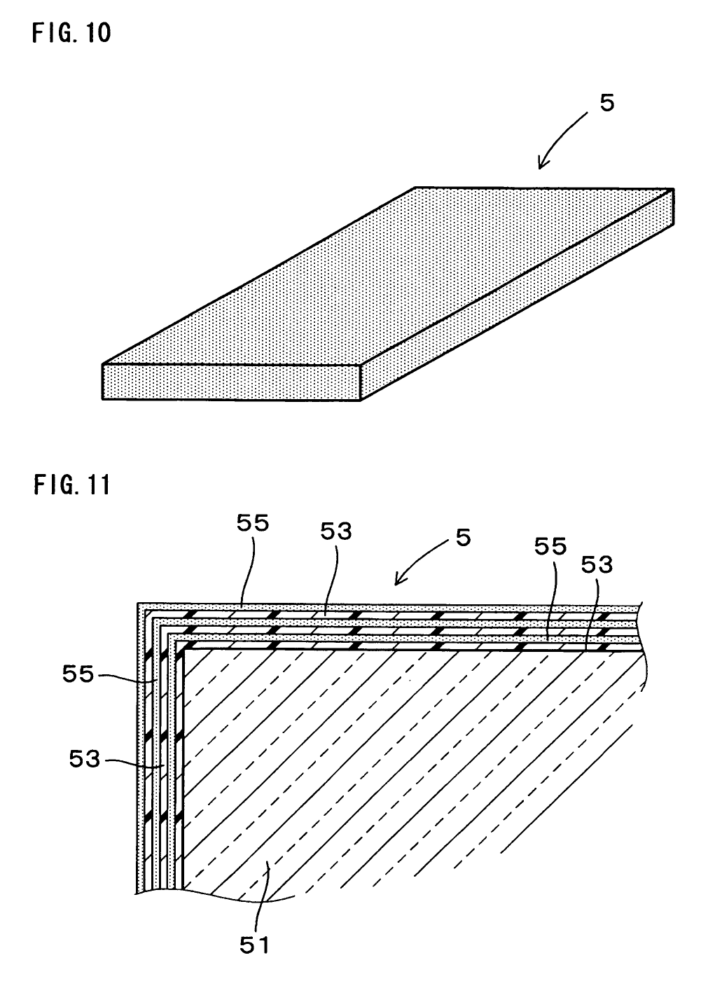

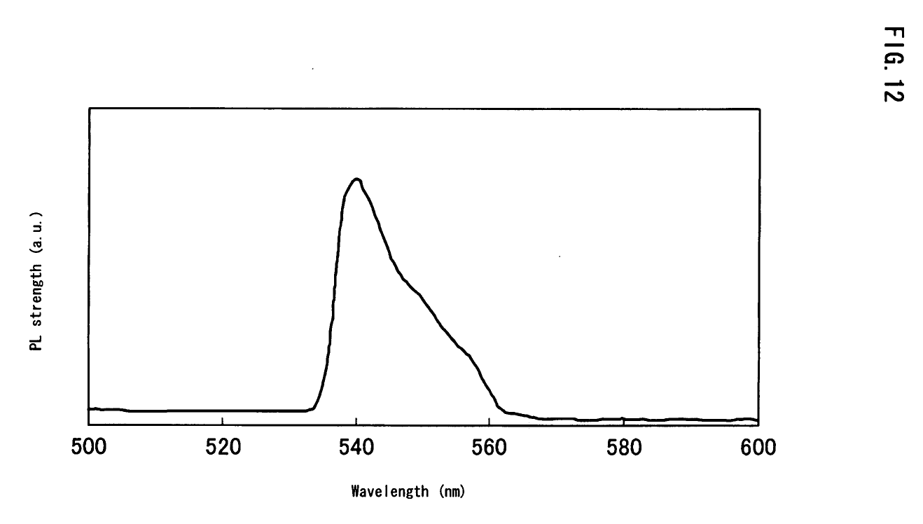

Following the procedure below, as shown in FIGS. 10 and 11, a nanosheet-containing composite 5 wherein three resin layers 53 and three nanosheet layers 55 were laminated alternately on the surface of a substrate 51 was produced.

Firstly, a quartz glass substrate 20 mm×20 mm in area and 2 mm in thickness was prepared as the substrate. Further, a nanosheet solution prepared in Example 1 and a polymer solution containing PDADMAC and NaCl were prepared. In the polymer solution, the concentration of the PDADMAC was 1 mg/mL and the concentration of the NaCl was 0.5 M. Furthermore, water was prepared for washing.

Successively, the glass substrate was immersed in the polymer solution and dried, and thus a resin layer comprising the PDADMAC was formed on the surface of the glass substrate (a resin layer forming step). The glass substrate was washed with water and dried (a washing step). Thereafter, the glass substrate was immersed in the nanosheet solution and dried again, and thereby a nanosheet layer comprising a silicon nanosheet was formed on the resin layer (a nanosheet layer forming step). After the glass substrate was washed again with water, the resin layer forming step, the washing step, and the nanosheet forming step were further applied repeatedly.

2. Evaluation

The fluorescence spectrum of the obtained nanosheet-containing composite was measured with a fluorescence spectrophotometer (FP-6600, made by JASCO Corporation). The fluorescence spectrum obtained when the excitation wavelength was set at 450 nm is shown in FIG. 12. As shown in FIG. 12, in the case of the nanosheet-containing composite of the present example, the peak was observed at the wavelength of 540±5 nm. That is, it was found that the nanosheet-containing composite of the present example emitted fluorescence in the visible light range.

Further, when the nanosheet-containing composite was subjected to heat treatment at 800° C. to 1,000° C. in a vacuum (10⁻⁵ Pa or lower), hydrogen and a hydroxyl in the silicon nanosheets were removed and a silicon membrane could be formed on the glass substrate.

### Example 4

A nanosheet solution produced in Example 1 was freeze-dried and thus a nanosheet aggregate was obtained. Specifically, a nanosheet solution adjusted to 0.5% by weight was frozen with liquid nitrogen and, by sucking the nanosheet solution with a rotary pump, the solvent was removed gradually. The nanosheet aggregate comprised fine particles (0.1 to 0.3 μm) and had a high surface to volume ratio (50 to 200 m²/g).

### Example 5

A nanosheet solution was produced following the same procedure as Example 1 except that YbSi₂ (refer to FIG. 13) was used as the layered silicon compound.

It was confirmed that, in the obtained nanosheet solution, silicon nanosheets 7 each of which contained a silicon atom layer 75 having a nearly flat structure as shown in FIG. 14 dispersed in the solvent.

### Example 6

Following the same procedure as described in the item 1 of Example 1, a nanosheet solution was produced.

Successively, a siloxene compound of 0.2 g was added to an ethanol solution of P-1,2,3 (block copolymer, HO(CH₂CH₂O)₂₀(CH₂CH(CH₃)O)₇₀(CH₂CH₂O)₂₀H) the concentration of which was 0.01 mol/dm³, and shaken hard (an exfoliation step). As a result, a dark brown suspension wherein silicon nanosheets dispersed was obtained.

When the suspension was put in a beaker and irradiated with light from one side, a Tyndall phenomenon intrinsic to a colloidal solution appeared. More specifically, it was understood that the suspension was a colloidal solution wherein silicon nanosheets suspended.

As stated above, it was understood that, even when a neutral surfactant was used as a surfactant, it was possible to produce a colloidal solution wherein silicon nanosheets dispersed.

### Example 7

1. Production of a Nanosheet Solution

CaSi₂ (0.1 g) was dispersed in a solvent comprising the mixture of propylamine (2 mL) and distilled water (8 mL). The mixture was subjected to hydrothermal treatment at 120° C. for 3 days in a beaker made of tetrafluoroethylene. Thereafter, unreacted materials were centrifugally separated at the number of revolutions of 10,000 rpm and the supernatant liquid was fractionated.

2. Evaluation of a Structure

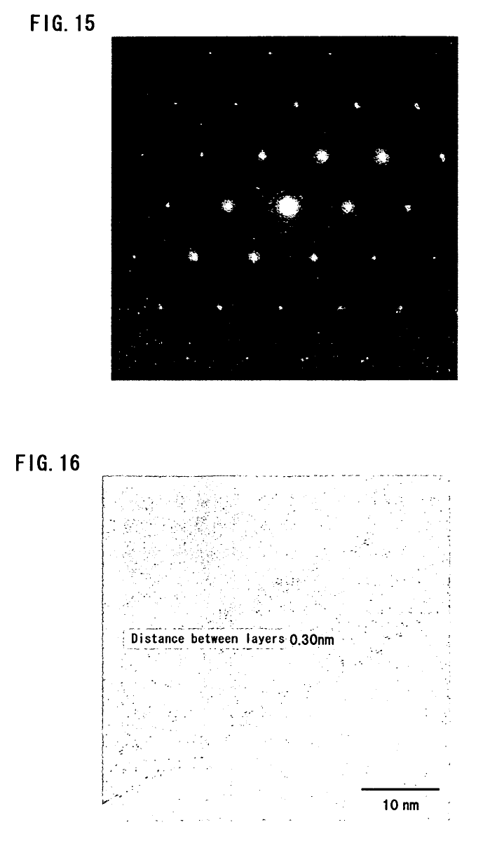

FIG. 15 shows an electron diffraction pattern on the planes of a silicon nanosheet contained in the obtained nanosheet solution. From FIG. 15, it was understood that the spots appeared in the form of a regular hexagon and had hexagonally rotational symmetry. The obtained spots appeared at the positions of 0.215 nm and 0.124 nm and were indexed as (220) and (440), respectively. Assuming that the diffraction spots were based on the ≦111> incidence, the spacing of lattice planes was about 10% larger in comparison with the values of bulk Si (0.192 nm in the case of Si (220) and 0.096 nm in the case of Si (440)).

Further, an end of a silicon nanosheet sometimes uprose and the shape of the lamination of the sheets was precisely observed from the end portion. A TEM photograph of an end of a silicon nanosheet is shown in FIG. 16. From FIG. 16, it was understood that the observed nanosheet had a layered structure comprising 20 to 30 layers. The distance between layers was 0.30 nm in the actual measurement.

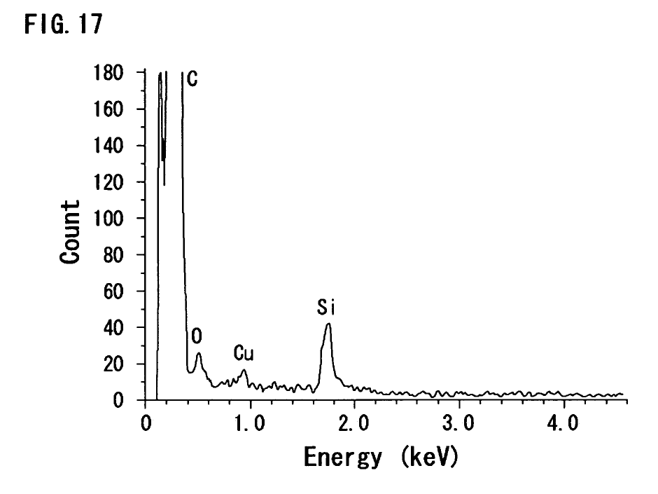

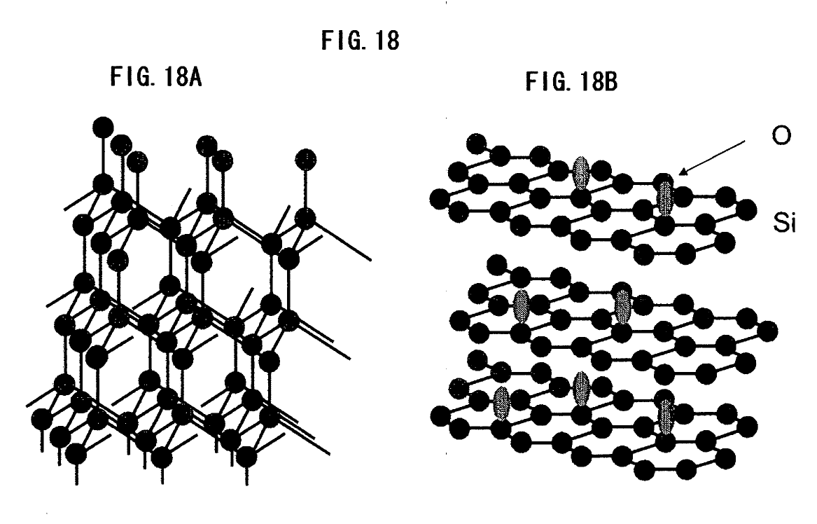

A result of EDX analysis of a silicon nanosheet is shown in FIG. 17. In FIG. 17, the counts of C and Cu were caused by the grid during the TEM observation. From FIG. 17, it was understood that, besides Si, oxygen was included in the nanosheet.

From the above results, the silicon nanosheet obtained in the present example could be indexed on the basis of a hexagonal system, and the lattice constants were determined as a=0.43 nm and c=0.30 nm. On the other hand, CaSi₂ as the starting material was indexed as a=0.38 nm and c=0.31 nm on the basis of the hexagonal system. This showed that the error was too large to regard the silicon nanosheet obtained in the present example as comprising conventional sp³ orbits. Then assuming that the silicon nanosheet comprised sp² obits like graphite (a planar structure) and the distance of Si—Si bond was 0.25 nm, the lattice constants of the hexagonal system were a=0.43 nm and c=0.30 nm and the result well coincided with the actual measurement. Taking the result together with the results of FIGS. 15 and 16 into consideration, it was estimated that the silicon nanosheet obtained in the present example had a structure formed by laminating silicon atom layers each of which had a planar structure as shown in FIG. 18B.

3. Evaluation of Photophysical Properties

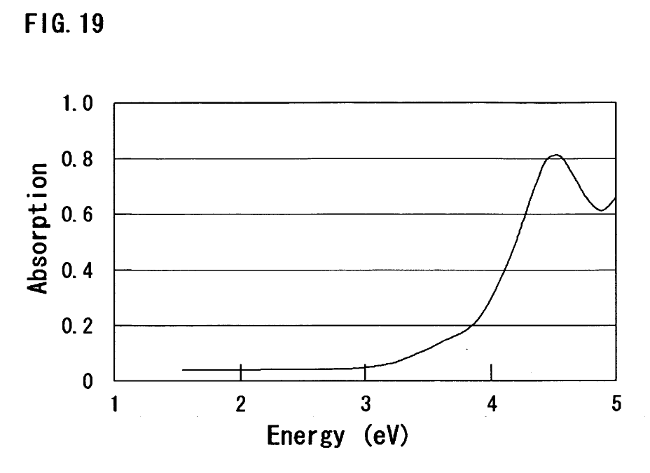

A nanosheet solution containing silicon nanosheets by 1% by weight was subjected to UV-vis measurement. The result is shown in FIG. 19. From FIG. 19, in the case of the silicon nanosheet obtained in the present example, the bandgap obtained from the absorption edge of the rising portion was 3.6 eV. The value meant the expression of quantum effect. More specifically, the value supported the fact that the nanosheets dispersing in the solution were nanosized silicon of 1 nm or less.

In the above explanations, the embodiments according to the present invention have been described in detail. However, the present invention is not limited to the above embodiments at all and various modifications are also included in the present invention in the range not deviating from the tenor of the present invention.

1. A silicon nanosheet comprising a silicon atom layer formed by bonding two-dimensionally and periodically arranged silicon atoms to each other through an Si—Si bond.

2. The silicon nanosheet according to claim 1,
wherein, in the silicon atom layer, Si six-membered rings are arranged two-dimensionally and periodically, and
among six silicon atoms constituting one of the Si six-membered rings, non-neighboring three silicon atoms are placed on a plane corresponding to a (111) plane of a diamond-structured Si, and the remaining three silicon atoms are placed on a plane corresponding to a (444) plane of the diamond-structured Si.

3. The silicon nanosheet according to claim 2, wherein the silicon atom layer is expressed with a chemical composition formula: Si₆H_{3-δ}(OH)_{3+δ}(0≦δ≦3).

4. The silicon nanosheet according to claim 2, wherein the silicon atom layer is expressed with a chemical composition formula: (SiH)ₙ.

5. The silicon nanosheet according to claim 1,
wherein, in the silicon atom layer, Si six-membered rings are arranged two-dimensionally and periodically, and
a distance between the Si six-membered rings composed of six silicon atoms in a direction perpendicular to a layer plane of the silicon atom layer is shorter than a distance between a (111) plane and a (444) plane of a diamond-structured Si.

6. The silicon nanosheet according to claim 5, wherein the silicon atom layer is expressed with a chemical composition formula: Si₆H_{3-δ}(OH)_{3+δ}(0≦δ≦3).

7. The silicon nanosheet according to claim 5, wherein the silicon atom layer is expressed with a chemical composition formula: SiOₓ (0≦x≦0.5).

8. The silicon nanosheet according to claim 1, wherein the silicon nanosheet comprises the single silicon atom layer.

9. The silicon nanosheet according to claim 8, wherein a thickness of the silicon nanosheet is 1 nm or less.

10. The silicon nanosheet according to claim 1, wherein the silicon nanosheet comprises a layered product formed by laminating a plurality of the silicon atom layers.

11. The silicon nanosheet according to claim 10, wherein the thickness of the silicon nanosheet is 10 nm or less.

12. The silicon nanosheet according to claim 1, wherein a part of the silicon atom layer is modified with an organic modified group.

13. The silicon nanosheet according to claim 1, wherein the silicon nanosheet shows a peak in a visible light region in measurement of a fluorescence spectrum.

14. The silicon nanosheet according to claim 13, wherein the silicon nanosheet shows a peak in a range of 450 to 600 nm when an excitation wavelength in a range of 400 to 500 nm is applied.

15. The silicon nanosheet according to claim 1, wherein a bandgap obtained by light absorption is 3.0 eV or more.

16. A nanosheet solution prepared by dispersing or suspending the silicon nanosheets according to claim 1 in a solvent.

17. The nanosheet solution according to claim 16, wherein the nanosheet solution shows a Tyndall phenomenon.

18. A nanosheet-containing composite having the silicon nanosheets according to claim 1 on a surface and/or in the interior of a substrate.

19. A nanosheet aggregate formed by aggregating the silicon nanosheets according to claim 1.

20. A process for producing a nanosheet solution, the process comprising:
treating a layered silicon compound with an aqueous acid solution to derive a siloxene compound; and
adding the siloxene compound into a solvent containing a surfactant, shaking the mixture, and peeling off the siloxene compound.

21. The process for producing a nanosheet solution according to claim 20, wherein the siloxene compound is peeled off until the thickness thereof is 10 nm or less in the exfoliation step.

22. The process for producing a nanosheet solution according to claim 20, wherein the siloxene compound is peeled off to form single layers in the exfoliation step.

23. The process for producing a nanosheet solution according to claim 20, wherein the siloxene compound is peeled off in an acidic environment in the exfoliation step.

24. The process for producing a nanosheet solution according to claim 20, wherein the surfactant is an anionic surfactant.

25. A process for producing a nanosheet solution, the process comprising:
dispersing a layered silicon compound in a solvent comprising a mixture of an amine having 3 or more carbon atoms and water and applying a hydrothermal treatment; and
separating unreacted materials.

26. The process for producing a nanosheet solution according to claim 25, wherein the hydrothermal treatment is applied at a temperature in a range of 120° C. to 180° C. for three days or longer.

27. A silicon nanosheet produced by a process according to claim 20.

28. A silicon nanosheet produced by a process according to claim 25.
